(19) United States
(12) Patent Application Publication
(10) Pub. No.: US 2026/0012122 A1
(43) Pub. Date: Jan. 8, 2026

(54) Insulated Roof Panels With Integrated Photovoltaic Panels

(71) Applicant: Pre-Insulated Metal Technologies, Inc., Vacaville, CA (US)

(72) Inventors: Brian NG, Hercules, CA (US); Luiz Fernando Moraes BENAZZI, Vancouver (CA)

(21) Appl. No.: 18/763,045

(22) Filed: Jul. 3, 2024

(51) Int. Cl. H02S 20/25; H02S 40/34; H02S 40/36

(52) U.S. Cl. CPC H02S 20/25; H02S 40/34; H02S 40/36

(57) ABSTRACT

An insulated panel has an inner skin, an outer skin and an insulated material between the inner and outer skins forming the insulated panel. At least one photovoltaic panel is adhered to the outer skin of the insulated panel. A pair of plates holds end edges of the photovoltaic panels. A clamp on each plate covers the end edges. At least one connector connects with the photovoltaic panels for transferring electricity from the photovoltaic panel.

### FIELD

The present disclosure relates to insulated panels and, more particularly, to insulated roof panels with integrated photovoltaic panels.

### BACKGROUND

Building construction utilizing insulated panels is well known. The insulated panels generally include an interior and exterior metal skin with insulation sandwiched between them. When manufacturing a building, the insulated roof panels can be of various lengths and sizes. Often it is desirable to have a photovoltaic panel, for electricity production purposes, positioned onto the roof. This happens at the installation of the building and photovoltaic panels are added to the insulated panels in the field. This necessitates a number of electrical connectors, piping and racking systems associated with the onsite addition of the photovoltaic panels in the field. Additionally, the junction boxes for the electrical components are generally positioned on the interior side of the panels and are not exposed to the external environment. The on-site construction of the photovoltaic panels is a labor intensive and time consuming ordeal to add the photovoltaic panels to the roof. Thus, designers strive to improve the art of the photovoltaic panels for the production of electricity.

The present disclosure is designed to seamlessly integrate the benefits of insulated metal standing seam roof panels with exceptional thermal insulation, weatherproofing through seam-type roofs, polyisocyanurate foam insulation, and the added advantage of electricity generation through integrated photovoltaic panels as a factory-assembled product. The disclosure effectively insulates the building, thereby reducing energy use, and generates electricity for the building. The present disclosure provides an integrated solution that enables fast installations of the system without labor intensive field installation of a photovoltaic system and traditional field installed racking systems that come with the prior art. The present disclosure provides photovoltaic panels without the need for an aluminum frame or a traditional rack mounting system. The photovoltaic panels are designed to accommodate the accepted widths of the insulated metal standing seam panels as well as a mechanical seamer to install the standing seam panels. The photovoltaic panels lay flush to the external steel sheet of the insulated metal standing seam roof panel with very little or no gap due to the lightly profiled face of the external steel sheet of the insulated panels.

### SUMMARY

According to a first aspect of the disclosure, an insulated panel comprises an inner skin, an outer skin and an insulated material between the inner and outer skins forming a panel. At least one photovoltaic panel is adhered to the outer skin of the insulated panel. A pair of plates hold the end edges of the photovoltaic panels onto the insulated panel. The clamp is on each end of the plate for covering the end edges. At least one connector connects with the photovoltaic panel to transfer electricity from the panel to an inverter or the like. The insulated panel has raised sides providing a deck between the sides. The photovoltaic panel is positioned and adhered to the deck. The photovoltaic panel has a thickness so that the photovoltaic panel's exposed surface is positioned below the terminal surface of the raised sides. A plurality of photovoltaic panels is arranged in a string connected with one another. The plate between adjacent photovoltaic panels include a clamp on each side for covering the adjacent ends of the photovoltaic panels. A junction box houses at least one connector. The junction box houses connectors from adjacent photovoltaic panels. The junction box, housing at least one connector, has an exposed surface that is positioned below the terminal surface of the raised sides. The raised sides are standing seams.

According to a second aspect of the disclosure, a roof comprises a plurality of insulated roof panels. Each panel has an inner skin, an outer skin and insulated material between the inner and outer skins forming the panel. A plurality of photovoltaic panels are adhered to the outer skin of each of the insulated panels. A plurality of plates for holding the end edges of the photovoltaic panels onto the insulated roof panel. At least one clamp is on each plate to cover the edge ends. At least one connector connects with each of the photovoltaic panels for transferring electricity from the panel an inverter or the like. The plurality of photovoltaic panels are arranged in a string and connected with another. At least one photovoltaic panel is adhered to the outer skin of the insulated panel. A pair of plates hold the end edges of the photovoltaic panels onto the insulated panel. The clamp is on each end of the plate for covering the end edges. At least one connector connects with the photovoltaic panel to transfer electricity from the panel to an inverter or the like. The insulated panel has raised sides providing a deck between the sides. At least one photovoltaic panel is positioned and adhered to the deck. The photovoltaic panel has a thickness so that the photovoltaic panel's exposed surface is positioned below the terminal surface of the raised sides. A plurality of photovoltaic panels is arranged in a string connected with one another. The plate between adjacent photovoltaic panels include a clamp on each side for covering the adjacent ends of the photovoltaic panels. A junction box houses at least one connector. The junction box houses connectors from adjacent photovoltaic panels. The junction box, housing at least one connector, has an exposed surface that is positioned below the terminal surface of the raised sides. The raised sides are standing seams.

According to a third aspect of the disclosure, a method for forming an insulated panel comprises of the steps of forming an insulated panel with an inner skin, an outer skin and insulated material between the inner and outer skins. Adhering at least one photovoltaic panel to the outer skin surface. Positioning a pair of plates at the end edges of the photovoltaic panels. Clamping an edge of the photovoltaic panels for securing the edge with the insulated panel. Connecting connectors with the photovoltaic panels for transferring electricity from the panels to an inverter, or the like.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of a building including a photovoltaic panel roof.

FIG. 2 is a perspective view of a single insulated roof panel with integrated photovoltaic panels.

FIG. 3 is a cross-section view of FIG. 2.

FIG. 4 is an enlarged perspective view of a holding plate.

FIG. 5 is a perspective view of an end of the panels.

FIG. 6 is a plan view of an insulated roof panel system in accordance with the disclosure.

### DETAILED DESCRIPTION OF THE PREFERRED EMBODIMENT

Example embodiments will now be described more fully with reference to the accompanying drawings. Corresponding reference numerals indicate corresponding parts reference to the accompanying drawings.

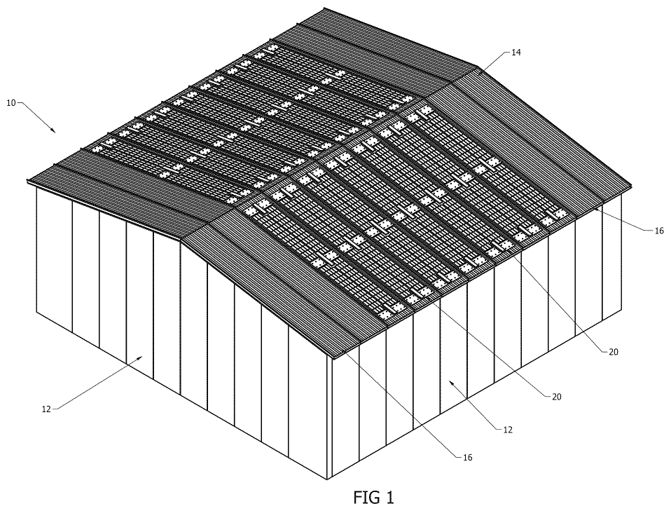

Turning to FIG. 1, a building is illustrated designated with the reference numeral 10. The building includes walls 12 and a roof 14. The roof is manufactured from a plurality of insulated roof panels 16. The insulated roof panels include at least one, preferably, an array of photovoltaic panels 20.

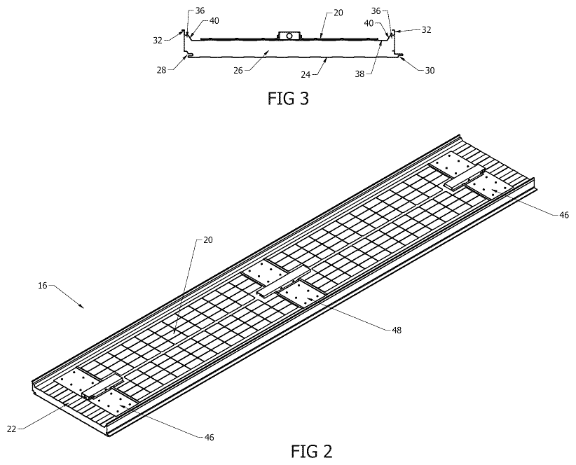

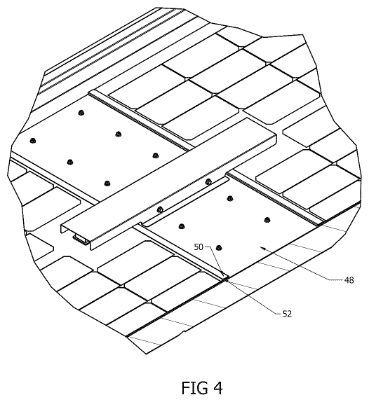

Turning to FIGS. 2 and 3, a single insulated roof panel with integrated photovoltaic panels is illustrated. The insulated roof panel 16 includes an exterior skin 22, an interior skin 24 and a foam insulated material 26 sandwiched between the two skins to form the insulated panel 16. The insulated roof panel 16 includes sides 28, 30 to connect with adjacent panels 16. Also, the insulated roof panels 16 include a standing seam connector 32 at its side. The standing seam connector 32 has an overall L-shape with the terminating surface positioned above the exterior skin 22.

The exterior skin 22 includes raised portions 36 at its sides that lead towards the seams 32. The raised portions 36 form a deck 38 between them which is lower with respect to the raised portions 36. The deck 38 is substantially planar and receives the photovoltaic panels 20. Thus, the photovoltaic panels 20 are positioned below the terminus of the raised portions 36 to provide a sleek appearance. Also, a gap 40 is positioned between the photovoltaic panels 20 and the standing seams 32. This enables a modified seaming machine to pass along the narrow pathway sides of the photovoltaic panels in a standard fashion to seal adjacent panel seams with one another.

The photovoltaic panels 20 are adhered to the insulated panel exterior skin 22 during the manufacturing process of the insulated panel 16. Thus, photovoltaic panels 20 are integrally adhered to the insulated roof panel 16 during the manufacturing process. Thus, this eliminates the on-site securement of the photovoltaic panels with the insulated panel.

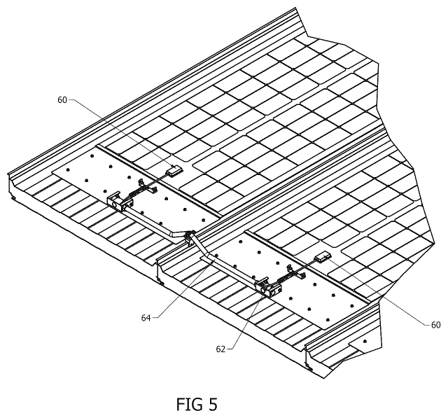

A plurality of holding plates 46, 48 are positioned at the ends of the photovoltaic panels 20. The plates 46 can have a singular clamp 50 or a dual clamp if the plate is positioned between adjacent photovoltaic panels 20. The plate 48 is illustrated in FIG. 4. The plates 46 relate to half of the plate 48 and only include a single clamp 50 since they are positioned at the terminating ends of the array or string of the photovoltaic panels 20. The clamps 50 have an L-shaped configuration and extends from the plate 48. The long leg or the horizontal leg 52 extends over the edge of the photovoltaic panel 20. Sealant adhesive can be inserted between the photovoltaic panel and the horizontal leg 52 of the clamp 50. This secures and seals the photovoltaic plate edge with respect to the plate 46, 48. Accordingly, the metal holding plates 46, 48 effectively secure and seal each photovoltaic lower and upper edge to provide protection against wind uplift, minimizing exposure to flames in the event of a fire and prevent water from entering underneath the photovoltaic panels. Further, the metal plates 46, 48 are designed to enable the use of traditional sandwich panel suction lifting equipment during installation of the insulated panel onto a roof.

Connectors 60, such as MC4 connectors, couple with the photovoltaic panel 20. The connectors 60 transfer the electricity from the photovoltaic panels 20 to a converter, inverter or the like. Generally, the connectors 60 can be coupled with one another in a string via a wire 62 passing through an EMT or PVC conduit 64. As can be seen in FIG. 5, the conduit has a V-shape to extend over the seam 32 between adjacent insulated roof panels 16.

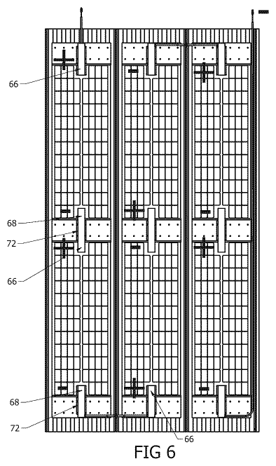

FIG. 6 illustrates an array of photovoltaic panels 20 in a series connection. Each photovoltaic panel has a positive end 66 and a negative end 68. The positive and negative ends 66, 68 of adjacent panels are positioned adjacent to one another as illustrated in FIG. 6. Also, the adjacent side panels 20 have the negative end adjacent the positive end. As seen in the six panel array in FIG. 6, the middle photovoltaic panels 20 are reversed so that the positive end is adjacent a side negative end. Also, junction boxes 70 are positioned on top of the electrical contacts. This provides for protection as well as housing the connector with respect to the environment. In between adjacent end to end panels, a double junction box 72 would be utilized to cover the connectors on each of the photovoltaic panels 20. As can be seen in FIG. 3, the junction box covers 70 are positioned below the terminus of the seams 32. Thus, nothing on the deck of the insulated panel 16 is above the seam. This makes the deck streamline and aesthetically appealing.

The insulated roof panel 16 is manufactured with the interior and exterior skins with the foam insulated sandwiched between the two skins. It is processed to provide the desired appearance. At least one photovoltaic panel is adhered to the outer skin of the insulated panel. A pair of plates are positioned onto the panel for holding the end edges of the photovoltaic panel. A clamp is on at least one end of the plate. The end covers the edge of the photovoltaic panel. At least one connector connects with the photovoltaic panel for transferring electricity from the panel to an inverter, a converter or the like.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An insulated roof panel comprising:
an inner skin, an outer skin and an insulated material between the inner and outer skins forming a panel;
at least one photovoltaic panel adhered to the outer skin of the panel;
a pair of plates for holding end edges of the photovoltaic panels, a clamp on each plate covering the end edge; and
at least one connector connecting with the photovoltaic panels for transferring electricity from the panel.

2. The insulated roof panel of claim 1, wherein the insulative panel has raised sides providing a deck between the raised sides.

3. The insulated roof panel of claim 2, wherein at least one photovoltaic panel is positioned and adhered to the deck, at least one photovoltaic panel having a thickness so that the panel exposed surface is below a terminal surface of the raised sides.

4. The insulated roof panel of claim 1, wherein a plurality of photovoltaic panels arranged in a string connected to one another.

5. The insulated roof panel of claim 1, wherein a plate between adjacent photovoltaic panels includes a clamp on each side for covering the end edges of adjacent photovoltaic panels.

6. The insulated roof panel of claim 1, wherein a junction box houses at least one connector.

7. The insulated roof panel of claim 5, wherein a junction box houses connectors from the adjacent photovoltaic panels.

8. The insulated roof panel of claim 3, wherein a junction box houses at least one connector and the junction box exposed surfaces is position below the terminal surface of the raised sides.

9. The roof insulated panel of claim 2, wherein the raised sides include a standing seam.

10. An insulated panel roof comprising:
a plurality of insulated roof panels each panel having
an inner skin, an outer skin and an insulated material between the inner and outer skins forming a panel;
a plurality of photovoltaic panel adhered to the outer skin of each of the insulated panels;
a plurality of plates for holding end edges of the photovoltaic panels, at least one clamp on each plate covering the end edge;
at least one connector connecting with the photovoltaic panels for transferring electricity from the panel; and
the plurality of photovoltaic panels arranged in a string connected to one another.

11. The insulated panel roof of claim 10, wherein the insulative panel has raised sides providing a deck between the raised sides.

12. The insulated panel roof of claim 11, wherein the plurality of photovoltaic panel is positioned and adhered to the deck, the plurality of photovoltaic panels having a thickness so that the panel exposed surface is below a terminal surface of the raised sides.

13. The insulated panel roof of claim 10, wherein the plates between adjacent photovoltaic panels includes a clamp on each side for covering the end edges on the adjacent photovoltaic panels.

14. The insulated panel roof of claim 10, wherein a plurality of junction boxes house the connectors.

15. The insulated panel roof of claim 12, wherein a plurality of junction boxes house the plurality connector and the junction boxes exposed surfaces is position below the terminal surface of the raised sides.

16. The insulated panel roof of claim 11, wherein the raised sides include standing seams.

17. A method of manufacturing an insulated roof panel integrated with photovoltaic panels comprising the steps of:
forming an insulated roof panel with an inner skin, an outer skin and an insulated material between the inner and outer skins adhering at least one photovoltaic panel to the outer skin of the insulated panel;
positioning a pair of plates for holding end edges of the photovoltaic panels;
covering the end edge of the photovoltaic panels with a clamp on each plate; and
connecting at least one connector with the photovoltaic panels for transferring electricity from the photovoltaic panel.
